(19) United States
(12) Patent Application Publication
(10) Pub. No.: US 2018/0100582 A1
(43) Pub. Date: Apr. 12, 2018

(54) SURFACE FLUORINATED ELASTOMERS FOR OILFIELD TOOLS

(71) Applicant: CNPC USA CORPORATION, Houston, TX (US)

(72) Inventors: Zhuo Li, Houston, TX (US); Jianhui Xu, Katy, TX (US)

(73) Assignee: CNPC USA CORPORATION, Houston, TX (US)

(21) Appl. No.: 15/782,488

(22) Filed: Oct. 12, 2017

Related U.S. Application Data
(60) Provisional application No. 62/407,068, filed on Oct. 12, 2016.

(51) Int. Cl. F16J 15/00

(52) U.S. Cl. CPC F16J 15/00; C08L 7/00

(57) ABSTRACT

Surface fluorination treatment of elastomers provides an oil-resistant, mechanically robust, and cost-effective elastomer for use as seals, O-rings, and plugs for oilfield tools. The fluorination treatment of the elastomers provides resistance to oil swelling.

### CROSS-REFERENCE TO RELATED APPLICATIONS

This application claims the benefit of U.S. Provisional Application No. 62/407,068, filed Oct. 12, 2016; hereby incorporated by reference in its entirety.

### FIELD

This invention relates to seals for oilfield tools, particularly to elastomers used for oilfield tool sealing.

### BACKGROUND

In the oil and gas industry, seals are used to isolate certain tools or wellbore sections from other tools, wellbore sections, fluids, etc. Seals also protect oilfield components from hostile environments. Seals may comprise many different types of materials depending upon the application for which they are intended to be put. In some cases where resiliency is needed, seals may be made wholly or partly from elastomers. Elastomers for oilfield seals are generally required to be oil-resistant, heat-resistant, chemical-resistant, and have good mechanical properties.

Among all the requirements, the oil-resistance requirement eliminates most of the common elastomers, such as natural rubber, ethylene propylene rubber (EPR), styrene butadiene rubber (SBR), ethylene propylene diene terpolymer (EPDM), because these elastomers are composed of carbon-hydrogen backbones and are prone to swell in oil. Currently, only high-end elastomers such as fluoroelastomers (FKM, tetrafluoro ethylene/propylene rubbers (FEPM) or perfluoro-elastomers (FFKM)) and nitrile rubber (NBR)/hydrogenated nitrile butadiene rubber (HNBR) can be used as seals in oilfield tools due to their good swelling resistance to oil. These elastomers, especially fluoroelastomers, are very costly and have a low rate of production, poor low temperature properties, and limited chemical resistance when exposed to steam, amine, and alkaline environment.

### SUMMARY

An embodiment of the disclosure is a seal for oilfield tool, comprising: an elastomer formed of a resilient material; and a fluorinated surface formed by fluorinating the surface of the elastomer. In an embodiment, the resilient material is a non-fluorinated elastomer, comprising at least one of the following materials: natural rubber, synthetic polyisoprene rubber, butadiene rubber, chloroprene rubber, butyl rubber, nitrile rubber, hydrogenated nitrile rubbers, epichlorohydrin rubber, polyacrylic rubber, silicone rubber, chlorosulfonated polyethylene, ethylene-vinyl acetate, ethylene propylene rubber, styrene butadiene rubber, or ethylene propylene diene terpolymer. In an embodiment, the thickness of the fluorinated surface ranges from 1 nm to 100 μm. In an embodiment, the thickness of the fluorinated surface ranges from 1 nm to 10 μm. In an embodiment, the thickness of the fluorinated surface ranges from 1 nm to 1 μm. In an embodiment, the thickness of the fluorinated surface ranges from 1 nm to 100 nm. In an embodiment, the thickness of the fluorinated surface ranges from 1 nm to 10 nm. In an embodiment, the fluorinated surface can be formed by a method selected from the group consisting of contacting the elastomer with dilute fluorine gas; plasma deposition of oil-repellent layers onto the surface of the elastomer; and vacuum deposition of oil-repellent layers onto the surface of the elastomer. In an embodiment, the fluorinated surface can be applied together with other surface treatment or process in order to achieve functional performance comprising at least one selected from the group consisting of corrosion resistance, erosion resistance, wear resistance, steam resistance, and coefficient of friction reduction. In an embodiment, the seals can be used in oilfield tools selected from the group consisting of a flange seal, a thread seal, a gasket, a cap seal, a compression seal, a diaphragm, a diaphragm seal, a ferrofluidic seal, a mechanical packing seal, an o-ring, a piston ring, a glass-to-metal seal, a ceramic-to-metal seal, a heat seal, a hose coupling, a hermetic seal, a grommet, a hydrostatic seal, a hydrodynamic seal, an oil seal ring, a seal protector, a bladder, a bladder tube, a bag, a bellows, a fluid containment chamber, a labyrinth section, a labyrinth protector, a labyrinth seal, a labyrinth tube, a lid seal, a face seal, a plug, a radial shaft seal, a split seal, a wiper seal, a dry gas seal, a lip seal, a cable sheath, a cable armor; Christmas tree, Blowout preventer, pipeline liner, O-ring, gasket, generator, pump, valves, joint, gauge, transmitter.

An embodiment of the disclosure is a seal for oilfield tool, comprising: an elastomer formed of a resilient material; a fluorinated surface formed by fluorinating the surface of the elastomer. In an embodiment, the resilient material is selected from a group consisting of one of the following materials: natural rubber, ethylene propylene rubber, styrene butadiene rubber, and ethylene propylene diene terpolymer. In an embodiment, the thickness of the fluorinated surface ranges from 1 nm to 100 μm. In an embodiment, the fluorinated surface can be formed by a method selected from the group consisting of contacting the elastomer with dilute fluorine gas; plasma deposition of oil-repellent layers onto the surface of the elastomer; and vacuum deposition of oil-repellent layers onto the surface of the elastomer.

An embodiment of the disclosure is a method of providing a seal in an oilfield tool comprising obtaining the seal; and installing the seal in the oilfield tool.

An embodiment of the disclosure is a method of manufacturing the seal, wherein the fluorinated surface is formed by a method selected from the group consisting of contacting the elastomer with dilute fluorine gas; plasma deposition of oil-repellent layers onto the surface of the elastomer; and vacuum deposition of oil-repellent layers onto the surface of the elastomer.

An embodiment of the disclosure is a method of manufacturing the seal 1, wherein the fluorinated surface is applied together with other surface treatment or process in order to achieve functional performance comprising at least one selected from the group consisting of corrosion resistance, erosion resistance, wear resistance, steam resistance, and coefficient of friction reduction.

The foregoing has outlined rather broadly the features of the present disclosure in order that the detailed description that follows may be better understood. Additional features and advantages of the disclosure will be described hereinafter, which form the subject of the claims.

### BRIEF DESCRIPTION OF THE DRAWINGS

In order that the manner in which the above-recited and other enhancements and objects of the disclosure are obtained, a more particular description of the disclosure briefly described above will be rendered by reference to specific embodiments thereof which are illustrated in the appended drawings. Understanding that these drawings depict only typical embodiments of the disclosure and are therefore not to be considered limiting of its scope, the disclosure will be described with additional specificity and detail through the use of the accompanying drawings in which:

FIG. 1 is a perspective half section view of an embodiment of an O-ring;

FIG. 2a is a view of a rubber element seal; FIG. 2b and FIG. 2c are half section views of the embodiments showing single layer of fluorination and multiple layer comprising of fluorination plus other functional layers, respectively.

FIG. 3 is a schematic illustration of the price comparison between different elastomers.

### DETAILED DESCRIPTION

The particulars shown herein are by way of example and for purposes of illustrative discussion of the preferred embodiments of the present disclosure only and are presented in the cause of providing what is believed to be the most useful and readily understood description of the principles and conceptual aspects of various embodiments of the disclosure. In this regard, no attempt is made to show structural details of the disclosure in more detail than is necessary for the fundamental understanding of the disclosure, the description taken with the drawings making apparent to those skilled in the art how the several forms of the disclosure may be embodied in practice.

The following definitions and explanations are meant and intended to be controlling in any future construction unless clearly and unambiguously modified in the following examples or when application of the meaning renders any construction meaningless or essentially meaningless. In cases where the construction of the term would render it meaningless or essentially meaningless, the definition should be taken from Webster's Dictionary 3rd Edition.

Oil-resistance is a surface property, it does not require the whole seal to be oil-resistant. Only the surface of the seal needs to be resistant to oil. Therefore, instead of using a fluoroelastomer, a common elastomer with a fluorinated surface can be used as a seal in oilfield applications. Disclosed herein is a seal made of a common elastomer with a fluorinated surface. The fluorinated surface is able to repel oil and protect the whole seal from oil swelling. Fluorination of the surface of rubbers seals forms an oleophobic surface. Because it is only a surface modification, the fluorination process does not damage the bulk properties of the seal, including but not limited to, mechanical properties, chemical resistance and heat resistance. This process greatly expands the range of rubbers that can be used in oilfield tools. Compared to the fluoroelastomers used currently, surface fluorinated non-fluoroelastomers such as EPDM have many advantages, including one order of magnitude lower price, better mechanical properties and in some cases, better chemical resistance to steam (steam injection wells or geothermal wells) or H₂S (sour environment wells). Elastomers can be used for including but not limited to isolatation and for surface protection from hostile environments.

Oilfield tools include but are not limited to downhole and surface tools. Oilfield tools include but are not limited to flange seal, a thread seal, a gasket, a cap seal, a compression seal, a diaphragm, a diaphragm seal, a ferrofluidic seal, a mechanical packing seal, an o-ring, a piston ring, a glass-to-metal seal, a ceramic-to-metal seal, a heat seal, a hose coupling, a hermetic seal, a grommet, a hydrostatic seal, a hydrodynamic seal, an oil seal ring, a seal protector, a bladder, a bladder tube, a bag, a bellows, a fluid containment chamber, a labyrinth section, a labyrinth protector, a labyrinth seal, a labyrinth tube, a lid seal, a face seal, a plug, a radial shaft seal, a split seal, a wiper seal, a dry gas seal, a lip seal, a cable sheath, a cable armor, Christmas tree, Blowout preventer, pipeline liner, O-ring, gasket, generator, pump, valves, joint, gauge, transmitter.

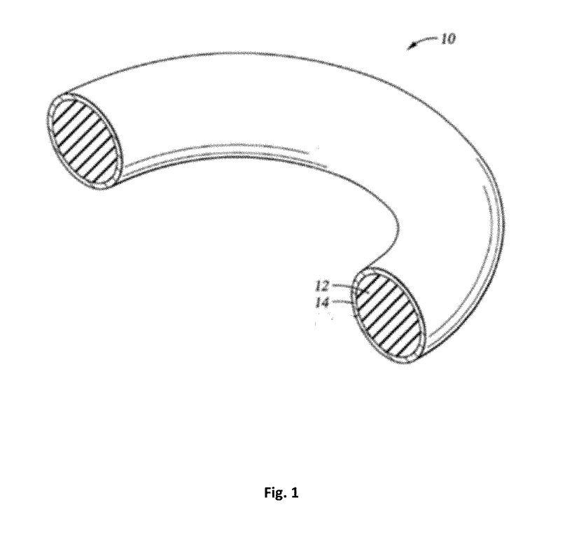

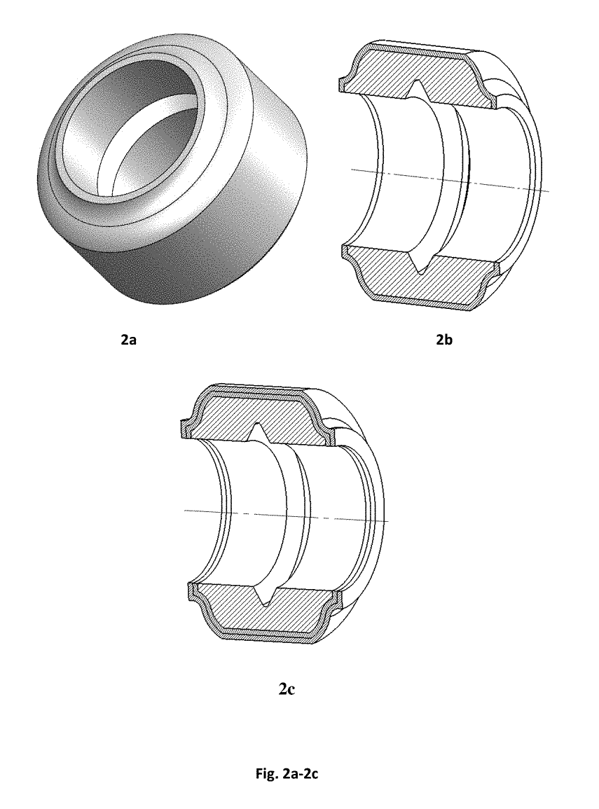

Referring to FIG. 1, a portion of an O-ring 10 is illustrated as an embodiment of a surface fluorinated seal. The O-ring 10 comprises an elastomer 12 which is formed from resilient materials, including but not limited to, natural rubber, ethylene propylene rubber (EPR), styrene butadiene rubber (SBR), and ethylene propylene diene terpolymer (EPDM). These resilient materials are non-fluorinated. FIG. 2a depicts view of a rubber element seal for use in oilfield packers, plugs, liner hangers, drill bits, O-rings, T-rings, gaskets, dart and other sealing tools. FIG. 2b shows the rubber element seal of the embodiment of a surface fluorination. FIG. 2c shows the rubber element seal of the embodiment of multiple layers comprising of a surface fluorination and other surface treatment or process for functions such as corrosion resistance, erosion resistance, wear resistance, steam resistance, and coefficient of friction reduction.

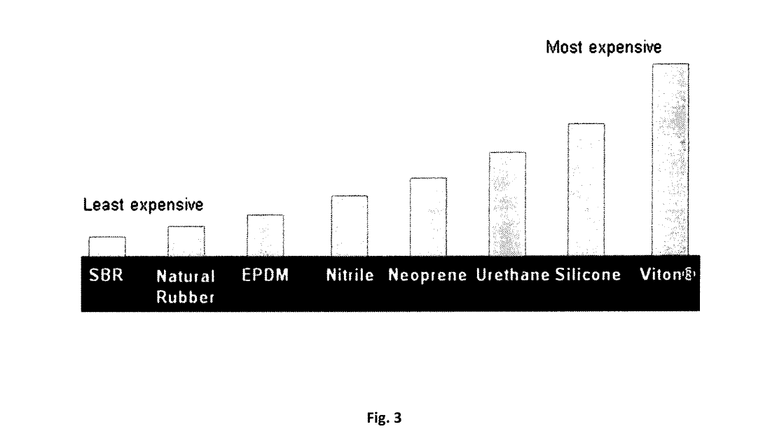

Referring to FIG. 3, a schematic illustration of the price comparison between different elastomers is provided. Viton is a kind of fluoroelastomer and is more expensive than other elastomers. Viton is much more expensive than common elastomers such as SBR, natural rubber, and EPDM. Therefore, by using common elastomers instead of fluoroelastomers, the cost of the O-ring 10 can be reduced by an order of magnitude.

Still referring to FIG. 1, the elastomer 12 is coated in a fluorination surface 14 which is formed by fluorinating the surface of the elastomer 12. There are many methods to fluorinate the surface of the elastomer 12. In one embodiment, the method comprises contacting the elastomer 12 with dilute fluorine gas at a temperature not substantially above about room temperature and at a pressure not substantially above about one atmosphere for a time adequate to fluorinate the surface of the elastomer 12 by forming stable fluorocarbon groups. In another embodiment, the method comprises plasma deposition of oil-repellent layers or vacuum deposition of oil-repellent layers onto the surface of the elastomer 12.

In an embodiment, the thickness of the fluorination surface 14 can range from 1 nm to 100 μm. This thickness is sufficient to protect the interior elastomer 12 from oil corrosion. Some common elastomers such as EPDM have better mechanical properties than fluoroelastomers. Table 1 shows mechanical property comparisons between fluoroelastomers and non-fluoroelastomers.

TABLE 1

| | Tensile strength | Tear resistance | Set resistance | Abrasion resistance |
|---|---|---|---|---|
| Fluoroelastomers | | | | |
| Aflas | Fair-Good | Poor-Fair | Poor-Fair | Good-Excellent |
| FKM | Good-Excellent | Fair | Excellent | Good |
| FFKM | Fair-Good | Poor-Fair | Good | Poor |
| Non-fluoroelastomers | | | | |
| NBR | Good-Excellent | Fair-Good | Good-Excellent | Good |
| HNBR | Excellent | Fair-Good | Good-Excellent | Excellent |
| EPDM | Good-Excellent | Good-Excellent | Good-Excellent | Good-Excellent |

Table 1 depicts comparisons of mechanical properties between fluoroelastomers and non-fluoroelastomers. Table 1 indicates that many non-fluoroelastomers have better tensile strength, set resistance, and abrasion resistance than fluoroelastomers. Furthermore, the tear resistance of non-fluoroelastomers is much better than that of fluoroelastomers. The thickness of the fluorination surface is small enough that the fluorination surface can hardly influence the mechanical properties of the elastomer 12. Therefore, a seal made from a common elastomer with a fluorinated surface can have better mechanical properties than a seal made from a fluoroelastomer.

The fluorinated surface of non-fluoroelastomers can be used in various sealing parts in oilfield tools, including but not limited to, sealing elements in packers, plugs, liner hangers, drill bits, O-rings, T-rings, gaskets, dart, and other sealing tools.

All of the compositions and methods disclosed and claimed herein can be made and executed without undue experimentation in light of the present disclosure. While the compositions and methods of this disclosure have been described in terms of preferred embodiments, it will be apparent to those of skill in the art that variations may be applied to the compositions and methods and in the steps or in the sequence of steps of the methods described herein without departing from the concept, spirit and scope of the disclosure. More specifically, it will be apparent that certain agents which are both chemically related may be substituted for the agents described herein while the same or similar results would be achieved. All such similar substitutes and modifications apparent to those skilled in the art are deemed to be within the spirit, scope and concept of the disclosure as defined by the appended claims.

What is claimed is:

1. A seal for an oilfield tool, comprising:
an elastomer formed of a resilient material;
a fluorinated surface formed by fluorinating the surface of the elastomer.

2. The seal of claim 1, wherein the resilient material is a non-fluorinated elastomer, comprising at least one of the following materials: natural rubber, synthetic polyisoprene rubber, butadiene rubber, chloroprene rubber, butyl rubber, nitrile rubber, hydrogenated nitrile rubbers, epichlorohydrin rubber, polyacrylic rubber, silicone rubber, chlorosulfonated polyethylene, ethylene-vinyl acetate, ethylene propylene rubber, styrene butadiene rubber, or ethylene propylene diene terpolymer.

3. The seal of claim 1, wherein the thickness of the fluorinated surface ranges from 1 nm to 100 μm.

4. The seal of claim 1, wherein the thickness of the fluorinated surface ranges from 1 nm to 10 μm.

5. The seal of claim 1, wherein the thickness of the fluorinated surface ranges from 1 nm to 1 μm.

6. The seal of claim 1, wherein the thickness of the fluorinated surface ranges from 1 nm to 100 nm.

7. The seal of claim 1, wherein the thickness of the fluorinated surface ranges from 1 nm to 10 nm.

8. The seal of claim 1, wherein the fluorinated surface can be formed by a method selected from the group consisting of contacting the elastomer with dilute fluorine gas; plasma deposition of oil-repellent layers onto the surface of the elastomer; and vacuum deposition of oil-repellent layers onto the surface of the elastomer.

9. The seal of claim 1, wherein the fluorinated surface can be applied together with other surface treatment or process in order to achieve functional performance comprising at least one selected from the group consisting of corrosion resistance, erosion resistance, wear resistance, steam resistance, and coefficient of friction reduction.

10. The seal of claim 1, wherein the seals can be used in oilfield tools selected from the group consisting of a flange seal, a thread seal, a gasket, a cap seal, a compression seal, a diaphragm, a diaphragm seal, a ferrofluidic seal, a mechanical packing seal, an o-ring, a piston ring, a glass-to-metal seal, a ceramic-to-metal seal, a heat seal, a hose coupling, a hermetic seal, a grommet, a hydrostatic seal, a hydrodynamic seal, an oil seal ring, a seal protector, a bladder, a bladder tube, a bag, a bellows, a fluid containment chamber, a labyrinth section, a labyrinth protector, a labyrinth seal, a labyrinth tube, a lid seal, a face seal, a plug, a radial shaft seal, a split seal, a wiper seal, a dry gas seal, a lip seal, a cable sheath, a cable armor, Christmas tree, Blowout preventer, pipeline liner, O-ring, gasket, generator, pump, valves, joint, gauge, transmitter.

11. The seal of claim 2, herein the seals can be used in oilfield tools selected from the group consisting of a flange seal, a thread seal, a gasket, a cap seal, a compression seal, a diaphragm, a diaphragm seal, a ferrofluidic seal, a mechanical packing seal, an o-ring, a piston ring, a glass-to-metal seal, a ceramic-to-metal seal, a heat seal, a hose coupling, a hermetic seal, a grommet, a hydrostatic seal, a hydrodynamic seal, an oil seal ring, a seal protector, a bladder, a bladder tube, a bag, a bellows, a fluid containment chamber, a labyrinth section, a labyrinth protector, a labyrinth seal, a labyrinth tube, a lid seal, a face seal, a plug, a radial shaft seal, a split seal, a wiper seal, a dry gas seal, a lip seal, a cable sheath, a cable armor, Christmas tree, Blowout preventer, pipeline liner, O-ring, gasket, generator, pump, valves, joint, gauge, transmitter.

12. The seal of claim 3, wherein the seals can be used in oilfield tools selected from the group consisting of a flange seal, a thread seal, a gasket, a cap seal, a compression seal, a diaphragm, a diaphragm seal, a ferrofluidic seal, a mechanical packing seal, an o-ring, a piston ring, a glass-to-metal seal, a ceramic-to-metal seal, a heat seal, a hose coupling, a hermetic seal, a grommet, a hydrostatic seal, a hydrodynamic seal, an oil seal ring, a seal protector, a bladder, a bladder tube, a bag, a bellows, a fluid containment chamber, a labyrinth section, a labyrinth protector, a labyrinth seal, a labyrinth tube, a lid seal, a face seal, a plug, a radial shaft seal, a split seal, a wiper seal, a dry gas seal, a lip seal, a cable sheath, a cable armor, Christmas tree, Blowout preventer, pipeline liner, O-ring, gasket, generator, pump, valves, joint, gauge, transmitter.

13. The seal of claim 4, wherein the seals can be used in oilfield tools selected from the group consisting of a flange seal, a thread seal, a gasket, a cap seal, a compression seal, a diaphragm, a diaphragm seal, a ferrofluidic seal, a mechanical packing seal, an o-ring, a piston ring, a glass-to-metal seal, a ceramic-to-metal seal, a heat seal, a hose coupling, a hermetic seal, a grommet, a hydrostatic seal, a hydrodynamic seal, an oil seal ring, a seal protector, a bladder, a bladder tube, a bag, a bellows, a fluid containment chamber, a labyrinth section, a labyrinth protector, a labyrinth seal, a labyrinth tube, a lid seal, a face seal, a plug, a radial shaft seal, a split seal, a wiper seal, a dry gas seal, a lip seal, a cable sheath, a cable armor, Christmas tree, Blowout preventer, pipeline liner, O-ring, gasket, generator, pump, valves, joint, gauge, transmitter.

14. The seal of claim 5, wherein the seals can be used in oilfield tools selected from the group consisting of a flange seal, a thread seal, a gasket, a cap seal, a compression seal, a diaphragm, a diaphragm seal, a ferrofluidic seal, a mechanical packing seal, an o-ring, a piston ring, a glass-to-metal seal, a ceramic-to-metal seal, a heat seal, a hose coupling, a hermetic seal, a grommet, a hydrostatic seal, a hydrodynamic seal, an oil seal ring, a seal protector, a bladder, a bladder tube, a bag, a bellows, a fluid containment chamber, a labyrinth section, a labyrinth protector, a labyrinth seal, a labyrinth tube, a lid seal, a face seal, a plug, a radial shaft seal, a split seal, a wiper seal, a dry gas seal, a lip seal, a cable sheath, a cable armor, Christmas tree, Blowout preventer, pipeline liner, O-ring, gasket, generator, pump, valves, joint, gauge, transmitter.

15. The seal of claim 6, wherein the seals can be used in oilfield tools selected from the group consisting of a flange seal, a thread seal, a gasket, a cap seal, a compression seal, a diaphragm, a diaphragm seal, a ferrofluidic seal, a mechanical packing seal, an o-ring, a piston ring, a glass-to-metal seal, a ceramic-to-metal seal, a heat seal, a hose coupling, a hermetic seal, a grommet, a hydrostatic seal, a hydrodynamic seal, an oil seal ring, a seal protector, a bladder, a bladder tube, a bag, a bellows, a fluid containment chamber, a labyrinth section, a labyrinth protector, a labyrinth seal, a labyrinth tube, a lid seal, a face seal, a plug, a radial shaft seal, a split seal, a wiper seal, a dry gas seal, a lip seal, a cable sheath, a cable armor, Christmas tree, Blowout preventer, pipeline liner, O-ring, gasket, generator, pump, valves, joint, gauge, transmitter.

16. A method of providing a seal in an oilfield tool comprising
obtaining the seal of claim 1; and
installing the seal of claim 1 in the oilfield tool.

17. A method of manufacturing the seal of claim 1, wherein the fluorinated surface is formed by a method selected from the group consisting of contacting the elastomer with dilute fluorine gas; plasma deposition of oil-repellent layers onto the surface of the elastomer; and vacuum deposition of oil-repellent layers onto the surface of the elastomer.

18. A method of manufacturing the seal of claim 1, wherein the fluorinated surface is applied together with other surface treatment or process in order to achieve functional performance comprising at least one selected from the group consisting of corrosion resistance, erosion resistance, wear resistance, steam resistance, and coefficient of friction reduction.
